(19) United States
(12) Patent Application Publication
(10) Pub. No.: US 2025/0163948 A1
(43) Pub. Date: May 22, 2025

(54) Furniture Clip System

(71) Applicant: Sunjoy Industries Group Ltd., Galena, OH (US)

(72) Inventor: Yunzhi Zhu, Galena, OH (US)

(21) Appl. No.: 18/954,198

(22) Filed: Nov. 20, 2024

Related U.S. Application Data
(60) Provisional application No. 63/601,720, filed on Nov. 21, 2023.

(51) Int. Cl. F16B 12/32

(52) U.S. Cl. CPC F16B 12/32

(57) ABSTRACT

A furniture clip system includes a first frame member forming a part of a first furniture section; a second frame member forming a part of a second furniture section; a latch tab member connected to the second frame member; and a furniture clip assembly configured to removably couple the first frame member to the second frame member. The furniture clip assembly includes a latch member rotatably coupled to the first frame member, and configured to removably engage with the latch tab member so as to attach the first frame member to the second frame member; and a handle member operatively coupled to the latch member, the handle member configured to be rotatable between an engaged position where the latch member is locked into engagement with the latch tab member and a disengaged position where the latch member is not locked into engagement with the latch tab member.

### CROSS-REFERENCE TO RELATED APPLICATIONS

This patent application claims priority to, and incorporates by reference in its entirety, U.S. Provisional Patent Application No. 63/601,720, entitled “Furniture Clip System”, filed on Nov. 21, 2023.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The invention generally relates to a furniture clip system. More particularly, the invention relates to a furniture clip system that includes a furniture clip assembly configured to removably couple a first frame member of a first furniture section to a second frame member of a second furniture section.

### 2. Background

Modular or sectional furniture typically comprises a plurality of different furniture sections that can be arranged together to form a complete furniture unit. As such, modular or sectional furniture is readily adaptable to a myriad of different room configurations, which provides flexibility and convenience for a user thereof.

Although, the sections of some conventional modular or sectional furniture are not attached to one another, but rather are just placed adjacent to one another on a floor of a room. Because the sections of this conventional modular or sectional furniture are not attached, the furniture sections tend to shift during use, which undesirably results in the creation of gaps between the sections. In contrast, sections of other conventional modular or sectional furniture are attached using fastener-based connectors that require the use of tools, which results in a laborious assembly and disassembly of the sections when the modular or sectional furniture needs to be moved and relocated to another location.

Therefore, what is needed is a furniture clip system that allows furniture sections of a furniture item to be easily and securely attached to one another. In addition, a furniture clip system is needed that includes a furniture clip assembly that is removably attached to a frame member of a furniture section so that the furniture clip assembly is able to be dissembled by a user from a remainder of the furniture section.

### BRIEF SUMMARY OF EMBODIMENTS OF THE INVENTION

Accordingly, the present invention is directed to a furniture clip system that substantially obviates one or more problems resulting from the limitations and deficiencies of the related art.

In accordance with one or more embodiments of the present invention, there is provided a furniture clip system that includes a first frame member forming a part of a first furniture section; a second frame member forming a part of a second furniture section; a latch tab member connected to the second frame member; and a furniture clip assembly configured to removably couple the first frame member to the second frame member. The furniture clip assembly includes a latch member rotatably coupled to the first frame member, the latch member configured to removably engage with the latch tab member so as to attach the first frame member to the second frame member; and a handle member operatively coupled to the latch member, the handle member configured to be rotatable between an engaged position where the latch member is locked into engagement with the latch tab member and a disengaged position where the latch member is not locked into engagement with the latch tab member. In these one or more embodiments, the furniture clip assembly is removably attached to the first frame member so that the furniture clip assembly is able to be dissembled by a user from a remainder of the first furniture section.

In a further embodiment of the present invention, the furniture clip assembly further comprises a main body portion, the handle member being rotatable relative to the main body portion.

In yet a further embodiment, the latch member is adjustably connected to the main body portion of the furniture clip assembly so that a user is able to adjust a shaft length of the latch member to accommodate varying gaps between adjacent furniture sections.

In still a further embodiment, the main body portion of the furniture clip assembly comprises a first annular section that is spaced apart from a second annular section by a gap, the first annular section of the main body portion being connected to the second annular section by a U-shaped connector section.

In yet a further embodiment, the handle member of the furniture clip assembly comprises a handle portion connected to a central handle body portion, the handle portion extending outwardly from the central handle body portion, and the central handle body portion configured to be at least partially received within the main body portion of the furniture clip assembly.

In still a further embodiment, the first frame member comprises at least one clip support member extending outwardly from an interior side of the first frame member, the furniture clip assembly being removably attached to the first frame member by means of the at least one clip support member.

In yet a further embodiment, the furniture clip assembly further comprises a fastener member for removably attaching the furniture clip assembly to the at least one clip support member of the first frame member.

In still a further embodiment, the first frame member comprises at least one alignment stud extending from an exterior side of the first frame member, and the second frame member comprises at least one stud aperture that corresponds to the at least one alignment stud of the first frame member, the at least one alignment stud configured to be received within the at least one stud aperture when the first frame member is removably coupled to the second frame member.

In yet a further embodiment, the first furniture section and the second furniture section form at least part of a furniture item selected from a group consisting of a sofa, a chair, a table, a bench, and an ottoman.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a perspective view of a furniture clip system, according to a first illustrative embodiment of the invention, wherein first and second frame members of the furniture clip system are shown disassembled from one another;

FIG. 2 is another perspective view of the furniture clip system of FIG. 1, wherein illustrative steps for assembling the first frame member to the second frame member are depicted in detail views within FIG. 2;

FIG. 3 is yet another perspective view of the furniture clip system of FIG. 1, wherein the first and second frame members of the furniture clip system are shown assembled to one another;

FIG. 4 is an exploded perspective view of a furniture clip assembly of the furniture clip system of FIG. 1;

FIG. 5 is a perspective view of a furniture clip system, according to a second illustrative embodiment of the invention, wherein first and second frame members of the furniture clip system are shown disassembled from one another;

FIG. 6 is another perspective view of the furniture clip system of FIG. 5, wherein illustrative steps for assembling the first frame member to the second frame member are depicted in detail views within FIG. 6;

FIG. 7 is yet another perspective view of the furniture clip system of FIG. 5, wherein the first and second frame members of the furniture clip system are shown assembled to one another;

FIG. 8 is an exploded perspective view of a furniture clip assembly of the furniture clip system of FIG. 5;

FIG. 9 is a perspective view of a sectional sofa comprising the furniture clip system of FIG. 1;

FIG. 10 is an enlarged perspective view of a furniture clip assembly on the sectional sofa of FIG. 9, wherein the furniture clip assembly is depicted in a disengaged state;

FIG. 11 is another enlarged perspective view of the furniture clip assembly on the sectional sofa of FIG. 9, wherein the furniture clip assembly is depicted in an intermediate state prior to the engaged state;

FIG. 12 is a yet another enlarged perspective view of a furniture clip assembly on the sectional sofa of FIG. 9, wherein the furniture clip assembly is depicted in an engaged state;

FIG. 13 is an enlarged perspective view of a furniture clip assembly of the furniture clip system of FIG. 1, wherein the furniture clip assembly is shown in its disassembled state; and

FIG. 14 is an enlarged perspective view of a user disassembling a furniture clip assembly from a furniture section of the sectional sofa of FIG. 9.

Throughout the figures, the same parts are always denoted using the same reference characters so that, as a general rule, they will only be described once.

### DETAILED DESCRIPTION OF EMBODIMENTS OF THE INVENTION

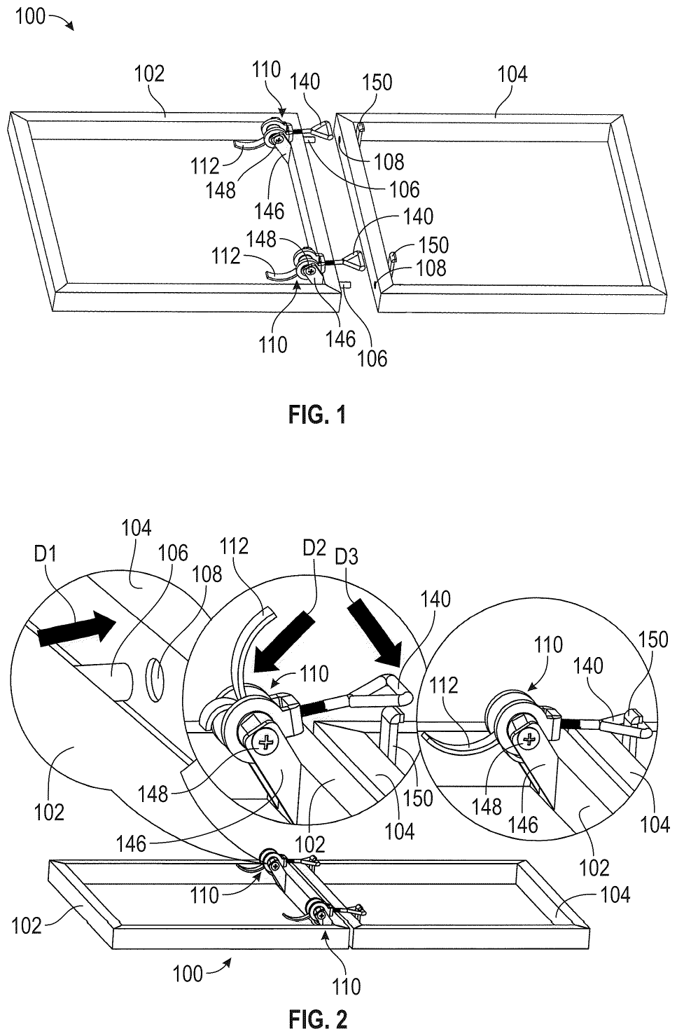

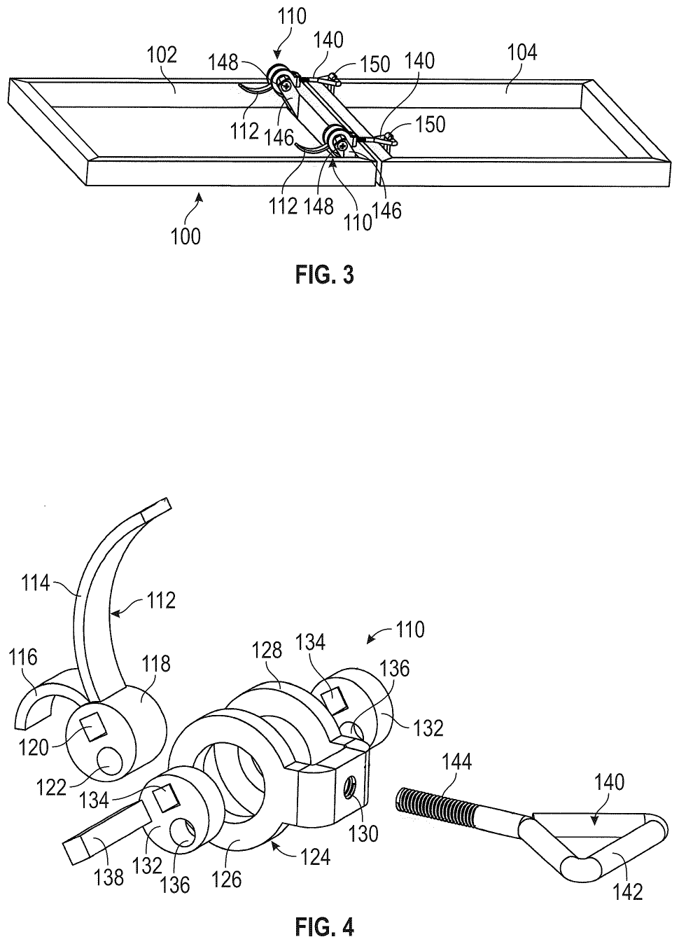

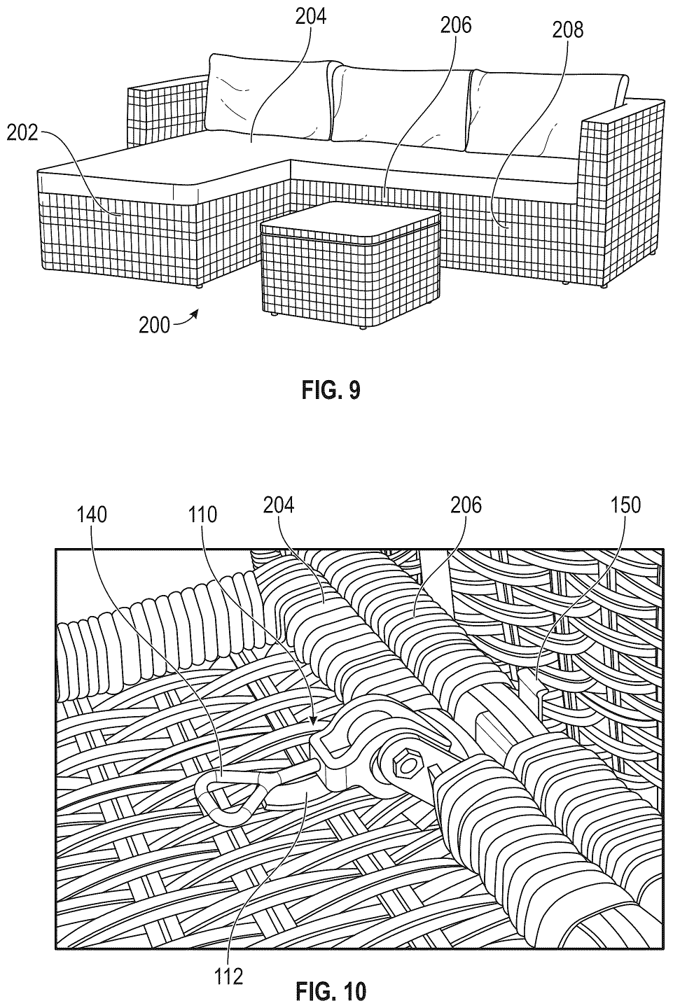

A first illustrative embodiment of a furniture clip system is seen generally at 100 in FIGS. 1-3. In particular, referring to the perspective views of FIGS. 1 and 3, it can be seen that the furniture clip system 100 generally comprises a first frame member 102 forming a part of a first furniture section (e.g., a first section of the sectional sofa in FIG. 9); a second frame member 104 forming a part of a second furniture section (e.g., a second section of the sectional sofa in FIG. 9); a latch tab member 150 connected to the second frame member 104; a furniture clip assembly 110 configured to removably couple the first frame member 102 to the second frame member 104, the furniture clip assembly 110 including a latch member 140 rotatably coupled to the first frame member 102, the latch member 140 configured to removably engage with the latch tab member 150 so as to attach the first frame member 102 to the second frame member 104; and a handle member 112 operatively coupled to the latch member 140, the handle member 112 configured to be rotatable between an engaged position where the latch member 140 is locked into engagement with the latch tab member 150 and a disengaged position where the latch member 140 is not locked into engagement with the latch tab member 150. The furniture clip assembly 110 is removably attached to the first frame member 102 so that the furniture clip assembly 110 is able to be dissembled by a user from a remainder of the first furniture section (e.g., a first section of the sectional sofa in FIG. 9).

In the illustrative embodiment, referring again to FIGS. 1-3, the first and second frame members 102, 104 may be formed from a plurality of tubular members having a generally square or rectangular cross-section. In the illustrative embodiment, the tubular members forming the first and second frame members 102, 104 may be formed from metal, and then welded together to form the square or rectangular-shaped frames.

Also, in the illustrative embodiment, with reference to FIG. 1, it can be seen that the first frame member 102 comprises a plurality of alignment studs 106 extending from an exterior side of the first frame member 102, while the second frame member 104 comprises a plurality of corresponding stud apertures 108. Each of the alignment studs 106 corresponds to a respective one of the stud apertures 108, and each of the alignment studs 106 is configured to be received within a respective one of the stud apertures 108 when the first frame member 102 is removably coupled to the second frame member 104 (i.e., each alignment stud 106 is inserted into a corresponding stud aperture 108). The mating of the alignment studs 106 with the stud apertures 108 advantageously facilitates a secure connection between the first frame member 102 and the second frame member 104.

In the illustrative embodiment, as shown in FIG. 4, the furniture clip assembly 110 further comprises a main body portion 124. The handle member 112 is rotatable relative to the main body portion 124. In the illustrative embodiment, referring again to FIG. 4, the main body portion 124 of the furniture clip assembly 110 comprises a first annular section 126 that is spaced apart from a second annular section 128 by a gap. The first annular section 126 of the main body portion 124 is connected to the second annular section 128 by a U-shaped connector section with a threaded aperture 130 disposed therein. In the illustrative embodiment, the first annular section 126 of the main body portion 124 is disposed generally parallel or parallel to the second annular section 128.

With combined reference to FIGS. 1-4, in the illustrative embodiment, it can be seen that the latch member 140 is adjustably connected to the main body portion 124 of the furniture clip assembly 110 so that a user is able to adjust a shaft length of the latch member 140 to accommodate varying gaps between adjacent furniture sections. More specifically, as shown in FIG. 4, the latch member 140 comprises a triangular latch portion 142 configured to engage the latch tab member 150 and a threaded shaft portion 144 extending outwardly from the triangular latch portion 142. The threaded shaft portion 144 of the latch member 140 is threadingly engaged with the threaded aperture 130 in the U-shaped connector section of the main body portion 124. By axially rotating the threaded shaft portion 144 within the threaded aperture 130, a user can adjust the effective extending length of the shaft portion 144 of the latch member 140 to accommodate varying gaps between adjacent furniture sections.

Now, with reference again to the illustrative embodiment of FIG. 4, it can be seen that the handle member 112 of the furniture clip assembly 110 comprises a first curved handle portion 114 connected to a central cylindrical handle body portion 118. The first curved handle portion 114 extends outwardly from the central cylindrical handle body portion 118. In the illustrative embodiment, the central cylindrical handle body portion 118 is configured to be received within the gap between the first annular sections 126, 128 of the main body portion 124 of the furniture clip assembly 110. Also, as shown in the illustrative embodiment of FIG. 4, the handle member 112 further comprises a second curved portion 116 that extends outwardly from the central cylindrical handle body portion 118. In the illustrative embodiment, the second curved portion 116 prevents the first curved handle portion 114 from rotating too far in a counter-clockwise direction when the first curved handle portion 114 is rotated into the engaged position of FIG. 3. In order to prevent the first curved handle portion 114 from rotating too far, the distal end of the second curved portion 116 contacts the interior side of the first frame member 102, which prevents the first curved handle portion 114 from rotating any further.

In the illustrative embodiment, referring again to the exploded view of FIG. 4, it can be seen that the central cylindrical handle body portion 118 of the handle member 112 comprises a first square aperture 120 disposed therethrough in an axial direction, and additionally comprises a second circular aperture 122 disposed therethrough in a parallel axial direction. In the illustrative embodiment, the first square aperture 120 receives a pin member 138 with a square cross-section, and the second circular aperture 122 receives a fastener member 148 (see FIGS. 1-3 and 13) for removably attaching the furniture clip assembly 110 to a pair of spaced-apart clip support members 146 on the first frame member 102. In the illustrative embodiment, as shown in FIGS. 1-3, the pair of spaced-apart clip support members 146 extend outwardly from an interior side of the first frame member 102. Each of the spaced-apart clip support members 146 is in a form of an angled bracket plate in the illustrative embodiment.

Next, turning again to FIG. 4, in the illustrative embodiment, it can be seen that the furniture clip assembly 110 further comprises a pair of side disks 132 that are configured to be disposed on opposite sides of the central cylindrical handle body portion 118 of the handle member 112. As shown in FIG. 4, each of the side disks 132 comprises a first square aperture 134 disposed therethrough in an axial direction, and additionally comprises a second circular aperture 136 disposed therethrough in a parallel axial direction. In the illustrative embodiment, similar to that described above for the central cylindrical handle body portion 118 of the handle member 112, the first square apertures 134 of the side disks 132 receive the pin member 138 with the square cross-section, and the second circular apertures 136 receive the fastener member 148 (see FIGS. 1-3 and 13) for removably attaching the furniture clip assembly 110 to the pair of spaced-apart clip support members 146 on the first frame member 102.

In the illustrative embodiment, during an assembly of the furniture clip assembly 110, the central cylindrical handle body portion 118 of the handle member 112 initially may be inserted between the first and second annular sections 126, 128 of the clip main body portion 124. Then, the side disks 132 may be affixedly attached (e.g., by welding) to the opposed sides of the central cylindrical handle body portion 118 by inserting the side disks 132 into the respective apertures of the first and second annular sections 126, 128 of the clip main body portion 124. Next, the pin member 138 with the square cross-section may be inserted into the square apertures 120, 134 of the side disks 132 and the central cylindrical handle body portion 118. Finally, the furniture clip assembly 110 may be attached to the pair of spaced-apart clip support members 146 by inserting the fastener member 148 into the circular apertures 122, 136 of the side disks 132 and the central cylindrical handle body portion 118.

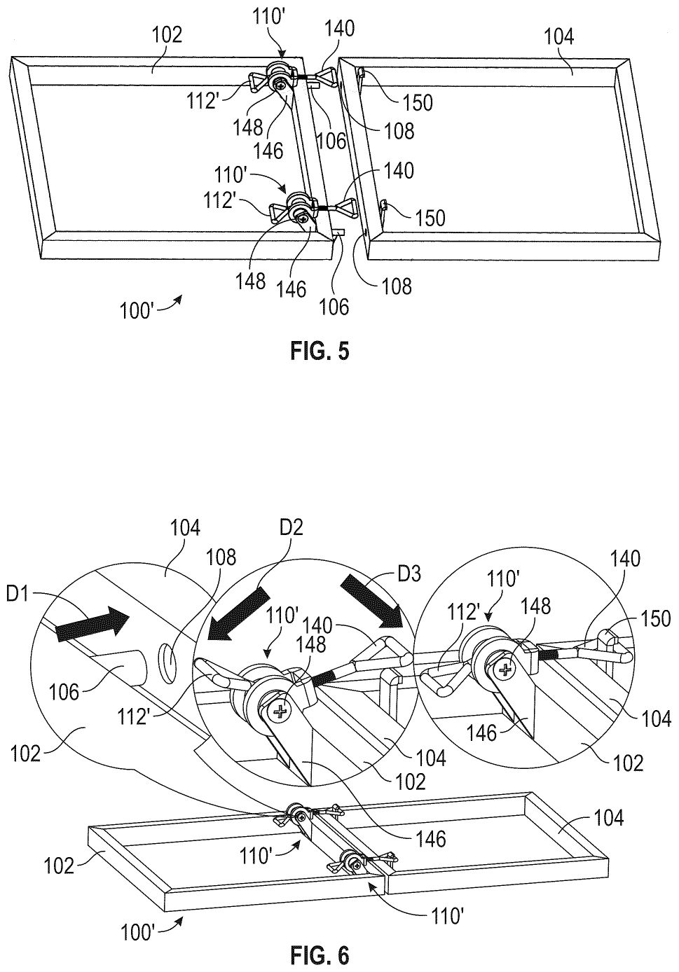

A second illustrative embodiment of a furniture clip system is seen generally at 100′ in FIGS. 5-8. Referring to these figures, it can be seen that, in most respects, the second illustrative embodiment is the same as the first illustrative embodiment. Moreover, most of the elements are common to both such embodiments. For the sake of brevity, the elements that the second embodiment of the furniture clip system has in common with the first embodiment will not be discussed in detail because these components have already been described above.

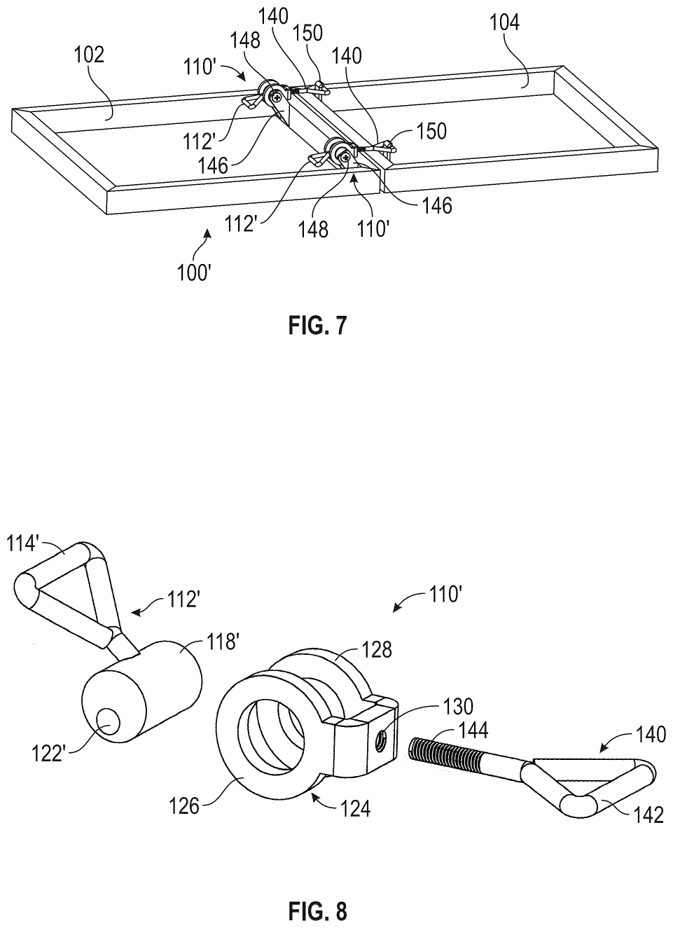

As shown in FIGS. 5 and 7, similar to the furniture clip system 100 described above, the furniture clip system 100′ generally comprises a first frame member 102 forming a part of a first furniture section (e.g., a first section of the sectional sofa in FIG. 9); a second frame member 104 forming a part of a second furniture section (e.g., a second section of the sectional sofa in FIG. 9); a latch tab member 150 connected to the second frame member 104; a furniture clip assembly 110′ configured to removably couple the first frame member 102 to the second frame member 104, the furniture clip assembly 110′ including a latch member 140 rotatably coupled to the first frame member 102, the latch member 140 configured to removably engage with the latch tab member 150 so as to attach the first frame member 102 to the second frame member 104; and a handle member 112′ operatively coupled to the latch member 140, the handle member 112′ configured to be rotatable between an engaged position where the latch member 140 is locked into engagement with the latch tab member 150 and a disengaged position where the latch member 140 is not locked into engagement with the latch tab member 150. The furniture clip assembly 110′ is removably attached to the first frame member 102 so that the furniture clip assembly 110′ is able to be dissembled by a user from a remainder of the first furniture section (e.g., a first section of the sectional sofa in FIG. 9).

In the second illustrative embodiment, referring again to FIGS. 5-7, the first and second frame members 102, 104 have the same construction and features as that described above for the first illustrative embodiment.

In the illustrative embodiment, as shown in FIG. 8, the furniture clip assembly 110′ further comprises a main body portion 124. The handle member 112′ is rotatable relative to the main body portion 124. In the illustrative embodiment, referring again to FIG. 8, the main body portion 124 of the furniture clip assembly 110′ comprises a first annular section 126 that is spaced apart from a second annular section 128 by a gap. The first annular section 126 of the main body portion 124 is connected to the second annular section 128 by a U-shaped connector section with a threaded aperture 130 disposed therein. In the illustrative embodiment, the first annular section 126 of the main body portion 124 is disposed generally parallel or parallel to the second annular section 128.

With combined reference to FIGS. 5-8, in the illustrative embodiment, it can be seen that the latch member 140 is adjustably connected to the main body portion 124 of the furniture clip assembly 110′ so that a user is able to adjust a shaft length of the latch member 140 to accommodate varying gaps between adjacent furniture sections. More specifically, as shown in FIG. 8, the latch member 140 comprises a triangular latch portion 142 configured to engage the latch tab member 150 and a threaded shaft portion 144 extending outwardly from the triangular latch portion 142. The threaded shaft portion 144 of the latch member 140 is threadingly engaged with the threaded aperture 130 in the U-shaped connector section of the main body portion 124. By axially rotating the threaded shaft portion 144 within the threaded aperture 130, a user can adjust the effective extending length of the shaft portion 144 of the latch member 140 to accommodate varying gaps between adjacent furniture sections.

Now, with reference again to the illustrative embodiment of FIG. 8, it can be seen that the handle member 112′ of the furniture clip assembly 110′ comprises a triangular handle portion 114′ connected to a central cylindrical handle body portion 118′ by a shaft portion of the triangular handle portion 114′. The triangular handle portion 114′ extends outwardly from the central cylindrical handle body portion 118′. In the illustrative embodiment, the central cylindrical handle body portion 118′ is configured to be received within the gap between the first annular sections 126, 128 of the main body portion 124 of the furniture clip assembly 110′.

In the illustrative embodiment, referring again to the exploded view of FIG. 8, it can be seen that central cylindrical handle body portion 118′ of the handle member 112′ comprises a circular aperture 122′ disposed therethrough in an axial direction of the central cylindrical handle body portion 118′. In the illustrative embodiment, the circular aperture 122′ receives the fastener member 148 (sec FIGS. 5-7) for removably attaching the furniture clip assembly 110′ to a pair of spaced-apart clip support members 146 on the first frame member 102. In the illustrative embodiment, as shown in FIGS. 5-7, the pair of spaced-apart clip support members 146 extend outwardly from an interior side of the first frame member 102. Each of the spaced-apart clip support members 146 is in a form of an angled bracket plate in the illustrative embodiment.

In the illustrative embodiment, during an assembly of the furniture clip assembly 110′, the central cylindrical handle body portion 118′ (without the triangular handle portion 114′ attached thereto) initially may be inserted into the apertures of the first and second annular sections 126, 128 of the clip main body portion 124. Then, the shaft portion of the triangular handle portion 114′ may be affixedly attached (e.g., by welding) to the curved sidewall of the central cylindrical handle body portion 118′. Finally, the furniture clip assembly 110′ may be attached to the pair of spaced-apart clip support members 146 by inserting the fastener member 148 into the circular aperture 122′ of the central cylindrical handle body portion 118′.

Now, referring to FIGS. 2 and 6, the illustrative manner in which a first frame member 102 of a first furniture section is attached to a second frame member 104 of a second furniture section will be described. Initially, as shown in FIGS. 2 and 6, the alignment studs 106 are inserted into their corresponding stud apertures 108 (as diagrammatically indicated by the arrow D1 in FIGS. 2 and 6). Then, the latch member 140 is rotated in a clockwise direction until the latch member 140 is hooked onto its corresponding latch tab 150 (as diagrammatically indicated by the arrow D3 in FIGS. 2 and 6). Also, prior to this step, to accommodate a particular gap width between adjacent furniture sections, a user can adjust the effective extending length of the shaft portion 144 of the latch member 140 by rotating the threaded shaft portion 144 of the latch member 140 within the threaded aperture 130 of the clip main body portion 124. After which, referring again to FIGS. 2 and 6, the handle member 112, 112′ is rotated in a counter-clockwise direction (as diagrammatically indicated by the arrow D2 in FIGS. 2 and 6) to an engaged position where the latch member 140 is pulled tight against its corresponding latch tab 150. When the handle member 112, 112′ is rotated in a counter-clockwise direction to the engaged position, the central cylindrical handle body portion 118, 118′ with the off-center fastener aperture 122, 122′ operates as an eccentric cam mechanism so as to pull the latch member 140 tight against its corresponding latch tab 150. As described above, in the first illustrative embodiment, the second curved portion 116 prevents the first curved handle portion 114 from rotating too far in a counter-clockwise direction when the first curved handle portion 114 is rotated into the engaged position.

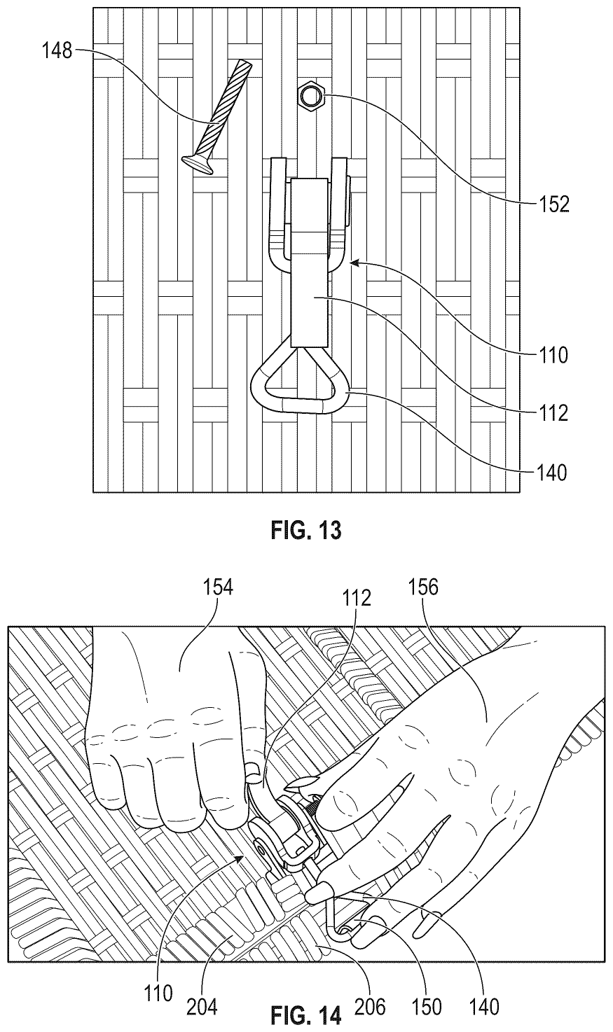

Next, referring to FIGS. 10-12, the illustrative manner in which furniture clip assembly 110 is disassembled will be described. Initially, a user rotates the handle member 112 in a clockwise direction to disengage the latch member 140 from the latch tab 150. Then, once the latch member 140 is disengaged from the latch tab 150, the user removes the fastener member 148 (e.g., a screw or bolt 148 with clip nut 152) from the side of the furniture clip assembly 110 (see FIG. 14). In the illustrative embodiment, the fastener member 148 is initially loosened with a tool, such as a screwdriver, and then removed by hand. For example, as shown in FIG. 14, a user may place his or her first hand 154 on the handle member 112 of the furniture clip assembly 110, while his or her second hand 156 is used to further loosen and remove the fastener member 148 from the furniture clip assembly 110. In FIG. 13, the furniture clip assembly 110 is illustrated in its disassembled state after being removed from the frame member of the furniture section. It is to be understood that the illustrative manner in which furniture clip assembly 110 is assembled on the furniture section is essentially the aforedescribed disassembly steps performed in reverse.

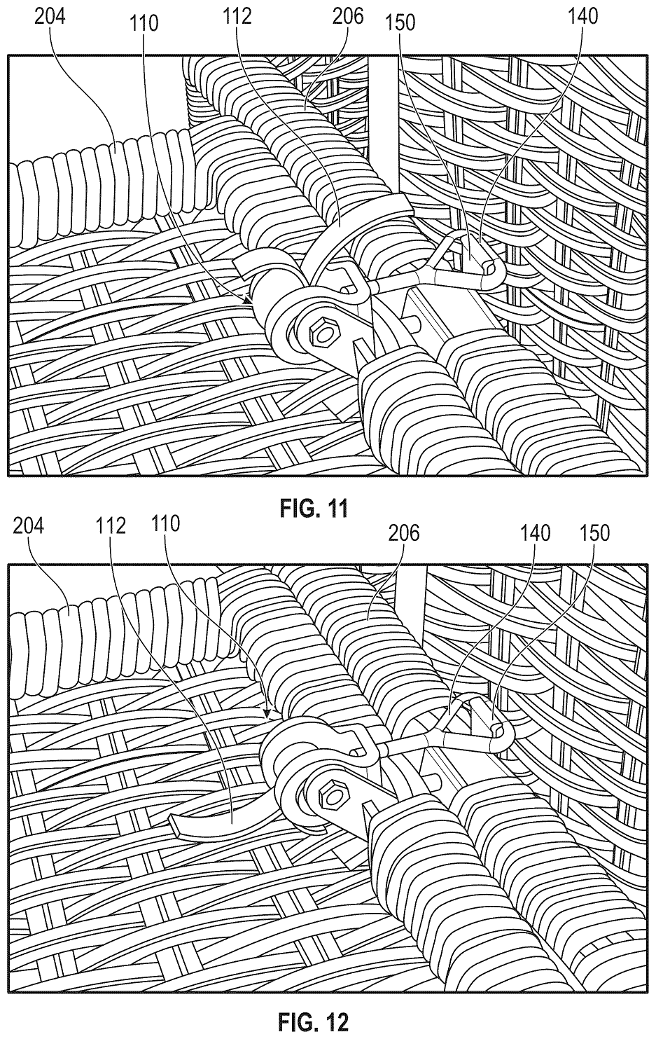

Turning to FIG. 9, a sectional or modular sofa 200, which utilizes the illustrative furniture clip system 100 described herein, is depicted. The sectional sofa 200 of FIG. 9 comprises a plurality of furniture sections 202, 204, 206, and 208 that are connected to one another by the furniture clip system 100. In FIG. 10, one furniture clip assembly 110 used to connect furniture sections 204, 206 of the sectional sofa 200 in FIG. 9 is depicted in its disengaged state. In FIG. 11, the furniture clip assembly 110 is depicted in an intermediate state prior to the engaged state, wherein the handle member 112 has not yet been rotated to the engaged state. In FIG. 12, the furniture clip assembly 110 is depicted in its engaged state, wherein the handle member 112 has been rotated to its engaged/locking position.

In addition to sectional or modular sofas, it is readily apparent that the furniture clip systems 100, 100′ may be used with a plurality of different furniture types, such as chairs, tables, benches, ottomans, etc. In the illustrative embodiment, the furniture clip assembly 110, 110′ may be preassembled on their furniture sections, and then may be disassembled, if desired, for after sales purposes.

It is readily apparent that the aforedescribed furniture clip system 100, 100′ offers numerous advantages. For example, in one or more embodiments, the furniture clip system 100, 100′ allows furniture sections of a furniture item to be easily and securely attached to one another. Moreover, in one or more embodiments, the furniture clip system 100, 100′ is removably attached to a frame member of a furniture section so that the furniture clip assembly 110, 110′ is able to be dissembled by a user from a remainder of the furniture section. Furthermore, in one or more embodiments, the furniture clip assembly 110, 110′ of the furniture clip system 100, 100′ is able to be engaged to, and disengaged from, a latch tab 150 without the use of any tools.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A furniture clip system, comprising:
a first frame member forming a part of a first furniture section;
a second frame member forming a part of a second furniture section;
a latch tab member connected to the second frame member; and
a furniture clip assembly configured to removably couple the first frame member to the second frame member, the furniture clip assembly including:
a latch member rotatably coupled to the first frame member, the latch member configured to removably engage with the latch tab member so as to attach the first frame member to the second frame member; and
a handle member operatively coupled to the latch member, the handle member configured to be rotatable between an engaged position where the latch member is locked into engagement with the latch tab member and a disengaged position where the latch member is not locked into engagement with the latch tab member;
wherein the furniture clip assembly is removably attached to the first frame member so that the furniture clip assembly is able to be dissembled by a user from a remainder of the first furniture section.

2. The furniture clip system according to claim 1, wherein the furniture clip assembly further comprises a main body portion, the handle member being rotatable relative to the main body portion.

3. The furniture clip system according to claim 2, wherein the latch member is adjustably connected to the main body portion of the furniture clip assembly so that a user is able to adjust a shaft length of the latch member to accommodate varying gaps between adjacent furniture sections.

4. The furniture clip system according to claim 2, wherein the main body portion of the furniture clip assembly comprises a first annular section that is spaced apart from a second annular section by a gap, the first annular section of the main body portion being connected to the second annular section by a U-shaped connector section.

5. The furniture clip system according to claim 2, wherein the handle member of the furniture clip assembly comprises a handle portion connected to a central handle body portion, the handle portion extending outwardly from the central handle body portion, and the central handle body portion configured to be at least partially received within the main body portion of the furniture clip assembly.

6. The furniture clip system according to claim 2, wherein the first frame member comprises at least one clip support member extending outwardly from an interior side of the first frame member, the furniture clip assembly being removably attached to the first frame member by means of the at least one clip support member.

7. The furniture clip system according to claim 6, wherein the furniture clip assembly further comprises a fastener member for removably attaching the furniture clip assembly to the at least one clip support member of the first frame member.

8. The furniture clip system according to claim 1, wherein the first frame member comprises at least one alignment stud extending from an exterior side of the first frame member, and the second frame member comprises at least one stud aperture that corresponds to the at least one alignment stud of the first frame member, the at least one alignment stud configured to be received within the at least one stud aperture when the first frame member is removably coupled to the second frame member.

9. The furniture clip system according to claim 1, wherein the first furniture section and the second furniture section form at least part of a furniture item selected from a group consisting of a sofa, a chair, a table, a bench, and an ottoman.
